(19) United States
(12) Patent Application Publication
(10) Pub. No.: US 2024/0258703 A1
(43) Pub. Date: Aug. 1, 2024

(54) METAL PLATE ANTENNA AND ANTENNA DEVICE

(71) Applicant: KABUSHIKI KAISHA TOKAI RIKA DENKI SEISAKUSHO, Aichi (JP)

(72) Inventors: Koji INAFUNE, Aichi (JP); Kenichi KOGA, Aichi (JP); Tatsuya KOIKE, Aichi (JP); Satoshi MORI, Aichi (JP)

(73) Assignee: KABUSHIKI KAISHA TOKAI RIKA DENKI SEISAKUSHO, Aichi (JP)

(21) Appl. No.: 18/397,038

(22) Filed: Dec. 27, 2023

(30) Foreign Application Priority Data
Jan. 30, 2023 (JP) 2023-011974

(51) Int. Cl. H01Q 9/42; H01Q 1/38

(52) U.S. Cl. CPC H01Q 9/42; H01Q 1/38

(57) ABSTRACT

There is provided a metal plate antenna arranged on a substrate, the metal plate antenna comprising: a parallel part arranged in substantially parallel to the substrate; a power feeding point contact part extended from the parallel part substantially perpendicularly to the parallel part, and provided in contact with a power feeding point with a metal foil pattern formed on the substrate and interposed therebetween; and a leg part formed separately from the power feeding point contact part, and extended from the parallel part substantially perpendicularly to the parallel part, wherein a contact area of the metal foil pattern and the power feeding point is narrower than a contact area of the metal foil pattern and the power feeding point contact part.

### CROSS REFERENCE TO RELATED APPLICATION(S)

This application is based upon and claims benefit of priority from Japanese Patent Application No. 2023-011974, filed on Jan. 30, 2023, the entire contents of which are incorporated herein by reference.

### BACKGROUND

The present invention relates to a metal plate antenna and an antenna device.

In recent years, various types of antennas have been developed. For example, Satoshi Honda and three others disclose a disc monopole antenna arranged on a substrate.

### SUMMARY

The antenna as disclosed by Satoshi Honda and three others has a problem of impedance matching. Furthermore, a devise for stably arranging the antenna as disclosed by Satoshi Honda and three others on the substrate is demanded.

The present invention has been made in light of the above problem, and an object of the present invention is to provide a metal plate antenna that achieves both of impedance matching and stable arrangement of the metal plate antenna on a substrate.

To solve the above described problem, according to an aspect of the present invention, there is provided a metal plate antenna arranged on a substrate, the metal plate antenna comprising: a parallel part arranged in substantially parallel to the substrate; a power feeding point contact part extended from the parallel part substantially perpendicularly to the parallel part, and provided in contact with a power feeding point with a metal foil pattern formed on the substrate and interposed therebetween; and a leg part formed separately from the power feeding point contact part, and extended from the parallel part substantially perpendicularly to the parallel part, wherein a contact area of the metal foil pattern and the power feeding point is narrower than a contact area of the metal foil pattern and the power feeding point contact part.

To solve the above described problem, according to another aspect of the present invention, there is provided an antenna device comprising: a substrate; and a metal plate antenna arranged on a substrate, wherein the metal plate antenna includes: a parallel part arranged in substantially parallel to the substrate; a power feeding point contact part extended from the parallel part substantially perpendicularly to the parallel part, and provided in contact with a power feeding point with a metal foil pattern formed on the substrate and interposed therebetween; and a leg part formed separately from the power feeding point contact part, and extended from the parallel part substantially perpendicularly to the parallel part, and a contact area of the metal foil pattern and the power feeding point is narrower than a contact area of the metal foil pattern and the power feeding point contact part.

As described above, the present invention can provide a metal plate antenna that achieves both of impedance matching and stable arrangement of the metal plate antenna on a substrate.

### BRIEF DESCRIPTION OF THE DRAWINGS

FIG. 1 is a diagram for describing a configuration example of a device for comparison 90.

FIG. 2 is a diagram for describing a configuration example in a case where an antenna device 10 according to an embodiment of the present invention includes a transmission line antenna 110.

FIG. 3 is a diagram for describing a configuration example in a case where the antenna device 10 according to the embodiment includes an inverted L antenna 120.

FIG. 4 is a diagram for describing a configuration example in a case where the antenna device 10 according to the embodiment includes an inverted F antenna 130.

FIG. 5 is a diagram for describing a configuration example in a case where the antenna device 10 according to the embodiment includes a branched power feeding transmission line antenna 140.

FIG. 6 is a diagram for describing a leg part that is in contact with a metal foil pattern 180 according to the embodiment.

FIG. 7 is a schematic diagram for describing a modified example of a leg part 116 according to the embodiment.

FIG. 8 is a diagram for describing opening parts 210 formed in the vicinity just above a contact portion of the leg part 116 and a substrate 150 according to the embodiment.

FIG. 9 is a diagram for describing slits 220 according to the embodiment.

FIG. 10 is a diagram for describing the slits 220 according to the embodiment.

FIG. 11 is a diagram for describing the opening parts 210 that are structures for causing a current to detour according to the embodiment.

FIG. 12 is a diagram illustrating a formation example of stabs 240 according to the embodiment.

FIG. 13 is a diagram illustrating an example of a mold structure according to the embodiment.

FIG. 14 is a diagram for describing the transmission line antenna 110 formed by a plurality of metal plates according to the embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

Furthermore, the same types of a plurality of existing components will be distinguished and described by assigning alphabets to ends of reference numerals in this description and the drawings in some cases. On the other hand, in a case where the same types of the plurality of existing components do not need to be distinguished, the above alphabets will be omitted, and common description will be made on all of the same types of the plurality of existing components in some cases.

### 1. Embodiment

### 1.1. Shape Examples of Metal Plate Antenna

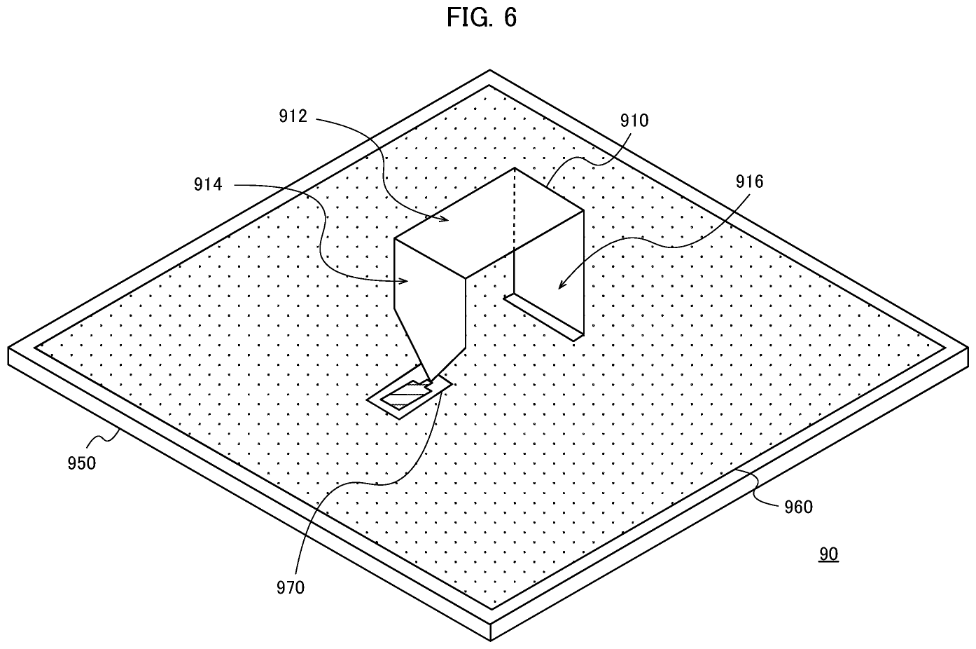

To describe the advantage of the metal plate antenna included in an antenna device 10 according to the embodiment of the present invention, a metal plate antenna 910 included in a device for comparison 90 will be described first with reference to FIG. 6.

FIG. 6 is a diagram illustrating a configuration example of the device for comparison 90. As illustrated in FIG. 6, the device for comparison 90 includes the metal plate antenna 910 arranged on a substrate 950.

The metal plate antenna 910 includes a parallel part 912 arranged in substantially parallel to the substrate 950, a power feeding point contact part 914 extended from the parallel part 912 substantially perpendicularly to the parallel part 912, and provided in contact with a power feeding point 970 arranged on the substrate 950, and a leg part 916 formed separately from the power feeding point contact part 914, extended from the parallel part 912 substantially perpendicularly to the parallel part 912, and provided in contact with a GND 960 formed on the substrate 950.

The metal plate antenna 910 is a transmission line antenna that operates as a one-wavelength (2) loop antenna using a mirror image formed using the GND 960 as a mirror surface.

Furthermore, the metal plate antenna 910 may be formed by press-machining one metal plate.

The power feeding point contact part 914 included in the metal plate antenna 910 may be formed such that the width of the lower end that is in contact with the power feeding point 970 is shorter than the width of the upper end as illustrated in FIG. 6.

According to the above shape, an effect of making it easier to perform impedance matching is expected.

However, in a case where the width of the lower end of the power feeding point contact part 914 that is in contact with the power feeding point 970 is made shorter (e.g., one mm or less), a precise press-machining technology is required.

Furthermore, in a case where the width of the lower end of the power feeding point contact part 914 that is in contact with the power feeding point 970 is made shorter, the metal plate antenna 910 may have difficulty in standing by itself on the substrate 950.

The metal plate antenna according to the embodiment of the present invention has been conceived focusing on the above point, and achieves both of impedance matching and stable arrangement of the metal plate antenna on the substrate.

Hence, the metal plate antenna included in the antenna device 10 according to the present embodiment has a characteristic shape described later.

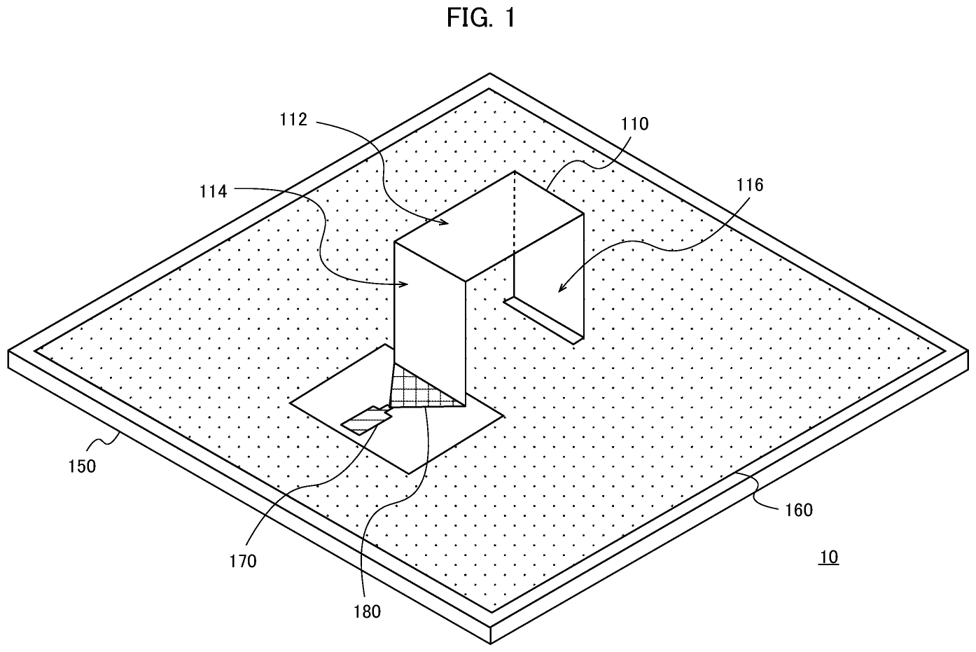

Hereinafter, the shape examples of the metal plate antenna according to the present embodiment will be described in detail with reference to each of FIGS. 1 to 4 in order.

FIG. 1 is a diagram for describing a configuration example in a case where the antenna device 10 according to the present embodiment includes a transmission line antenna 110.

As illustrated in FIG. 1, the antenna device 10 according to the present embodiment may include the transmission line antenna 110.

The transmission line antenna 110 according to the present embodiment includes a parallel part 112 arranged in substantially parallel to a substrate 150, a power feeding point contact part 114 extended from the parallel part 112 substantially perpendicularly to the parallel part 112, and provided in contact with a power feeding point 170 (indicated by diagonal lines) arranged on the substrate 150 with a metal foil pattern 180 (indicated by a lattice pattern) formed on the substrate 150 and interposed therebetween, and a leg part 116 formed separately from the power feeding point contact part 114, extended from the parallel part 112 substantially perpendicularly to the parallel part 112, and provided in contact with a GND 160 (indicated by a dot pattern) formed on the substrate 150.

Here, one of features of the antenna device 10 illustrated in FIG. 1 is that a contact area of the metal foil pattern 180 and the power feeding point 170 is narrower than a contact area of the metal foil pattern 180 and the power feeding point contact part 114.

According to the above feature, it is possible to more easily perform impedance matching similar to the device for comparison 90 illustrated in FIG. 6.

Furthermore, formation of the metal foil pattern 180 on the substrate 150 is easy and accurate compared to the above-described press-machining, so that the antenna device 10 according to the present embodiment provides an advantageous effect compared to the device for comparison 90.

Furthermore, in a case where the metal foil pattern 180 is formed as in the above feature, it is not necessary to machine the width of the lower end of the power feeding point contact part 114 short, so that it is possible to increase the contact area of the power feeding point contact part 114 and the substrate 150, and more stably arrange the metal plate antenna on the substrate 150.

Note that the metal foil pattern 180 may be formed using, for example, a copper foil.

In a case where the antenna device 10 includes the transmission line antenna 110, the transmission line antenna 110 is formed such that an antenna length defined by the lengths of the parallel part 112, the power feeding point contact part 114, and the leg part 116 is approximately ½ of the wavelength of a wireless signal that conforms to specific wireless communication standards.

In this regard, the metal plate antenna according to the present embodiment is not limited to the transmission line antenna illustrated in FIG. 1.

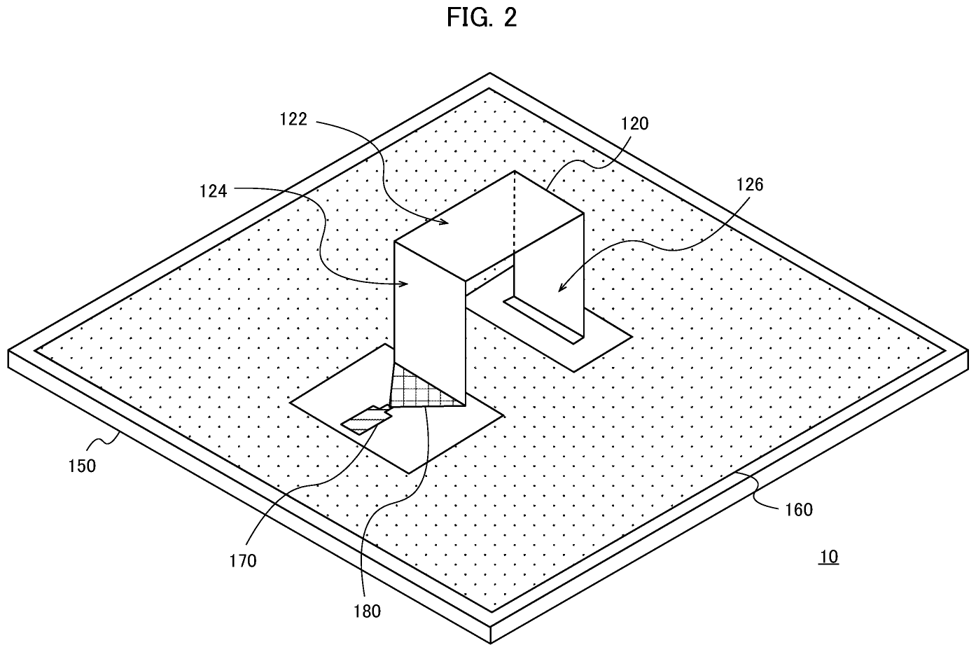

For example, the metal plate antenna according to the present embodiment may be an inverted L antenna 120 illustrated in FIG. 2.

The inverted L antenna 120 illustrated in FIG. 2 includes a parallel part 122 arranged in substantially parallel to a substrate 150, a power feeding point contact part 124 extended from the parallel part 122 substantially perpendicularly to the parallel part 122, and provided in contact with the power feeding point 170 arranged on the substrate 150 with the metal foil pattern 180 formed on the substrate 150 and interposed therebetween, and a leg part 126 formed separately from the power feeding point contact part 124, extended from the parallel part 122 substantially perpendicularly to the parallel part 122, and provided in contact with the substrate 150.

A contact portion of the leg part 126 and the substrate 150 is electrically insulated as illustrated in FIG. 2.

According to the above configuration, it is possible to achieve both of impedance matching and stable arrangement on the substrate.

In a case where the antenna device 10 includes the inverted L antenna 120, the inverted L antenna 120 is formed such that an antenna length defined by the lengths of the parallel part 122, the power feeding point contact part 124, and the leg part 126 is approximately ¼ of the wavelength of a wireless signal that conforms to the specific communication standards.

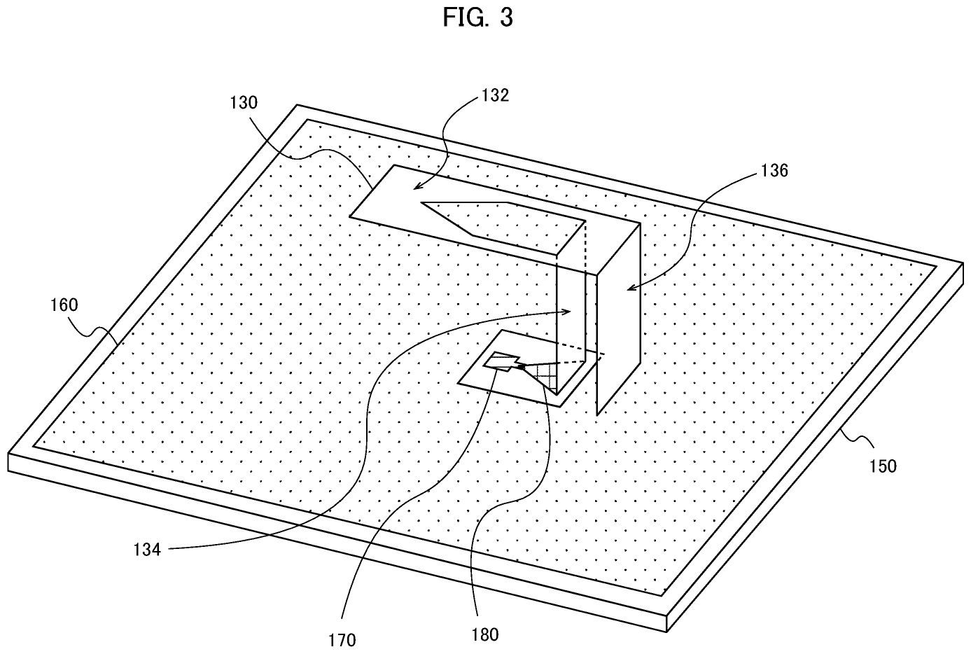

Furthermore, for example, the metal plate antenna according to the present embodiment may be an inverted F antenna 130 illustrated in FIG. 3.

The inverted F antenna 130 illustrated in FIG. 3 includes a parallel part 132 arranged in substantially parallel to the substrate 150, a power feeding point contact part 134 extended from the parallel part 132 substantially perpendicularly to the parallel part 132, and provided in contact with the power feeding point 170 arranged on the substrate 150 with the metal foil pattern 180 formed on the substrate 150 and interposed therebetween, and a leg part 136 formed separately from the power feeding point contact part 134, extended from the parallel part 132 substantially perpendicularly to the parallel part 132, and provided in contact with the GND 160 formed on the substrate 150.

According to the above configuration, it is possible to achieve both of impedance matching and stable arrangement on the substrate.

In a case where the antenna device 10 includes the inverted F antenna 130, the inverted F antenna 130 is formed such that an antenna length defined by the lengths of the parallel part 132, the power feeding point contact part 134, and the leg part 136 is approximately ¼ of the wavelength of a wireless signal that conforms to the specific communication standards.

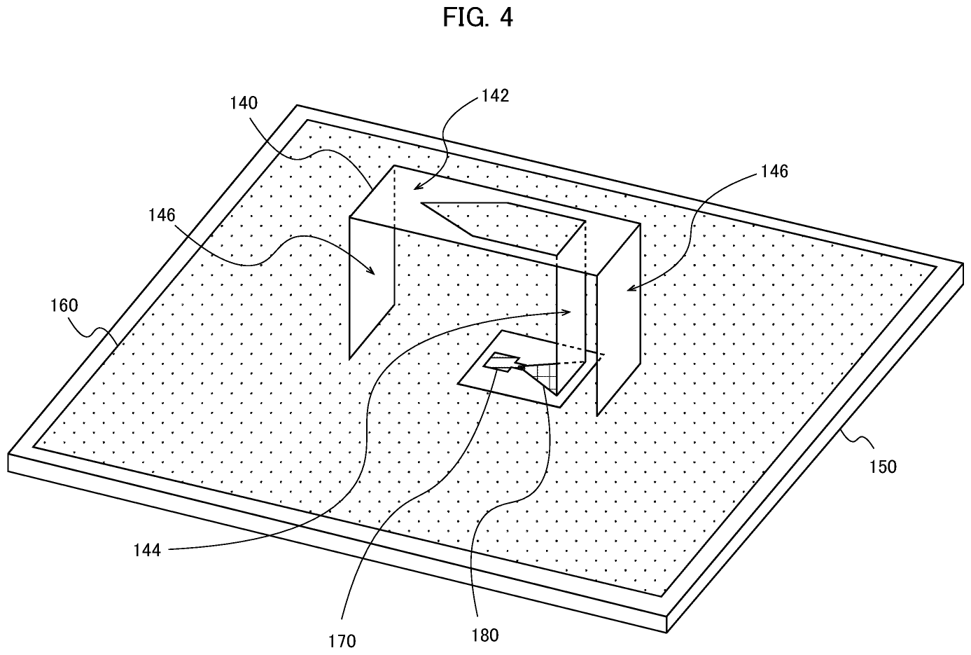

Furthermore, for example, the metal plate antenna according to the present embodiment may be a branched power feeding transmission line antenna 140 illustrated in FIG. 4.

The branched power feeding transmission line antenna 140 illustrated in FIG. 4 includes a parallel part 142 arranged in substantially parallel to the substrate 150, a power feeding point contact part 144 extended from the parallel part 142 substantially perpendicularly to the parallel part 142, and provided in contact with the power feeding point 170 arranged on the substrate 150 with the metal foil pattern 180 formed on the substrate 150 and interposed therebetween, and two leg parts 146 formed separately from the power feeding point contact part 144, respectively extended from the one end and the other end of the parallel part 142 substantially perpendicularly to the parallel part 142, and provided in contact with the GND 160 formed on the substrate 150.

According to the above configuration, it is possible to achieve both of impedance matching and stable arrangement on the substrate.

In a case where the antenna device 10 includes the branched power feeding transmission line antenna 140, the branched power feeding transmission line antenna 140 is formed such that an antenna length defined by the lengths of the parallel part 142, the power feeding point contact part 144, and the leg parts 146 is approximately ½ of the wavelength of a wireless signal that conforms to the specific communication standards.

The shape examples of the metal plate antenna according to the present embodiment have been described above. In this regard, the shape of each metal plate antenna described with reference to each of FIGS. 1 to 4 is merely an example, and the shapes of the metal plate antenna according to the present embodiment are not limited to these examples.

The antenna length defined by the lengths of the parallel part, the power feeding point contact part, and the leg part may be determined based on the wavelength of a wireless signal that conforms to the specific communication standards for the metal plate antenna according to the present embodiment to transmit and receive the wireless signal that conforms to the specific communication standards.

An example of the above specific communication standards includes Ultra-Wide Band (UWB) wireless communication.

Furthermore, the leg part included in the metal plate antenna according to the present embodiment may contact the metal foil pattern 180 arranged on the substrate 150.

FIG. 6 is a diagram illustrating a configuration example in a case where the leg part 116 included in the transmission line antenna 110 is in contact with the metal foil pattern 180 formed on the substrate 150.

When the leg part 116 is in more contact with the metal foil pattern 180, an effect of making it easier to adjust impedance matching is expected.

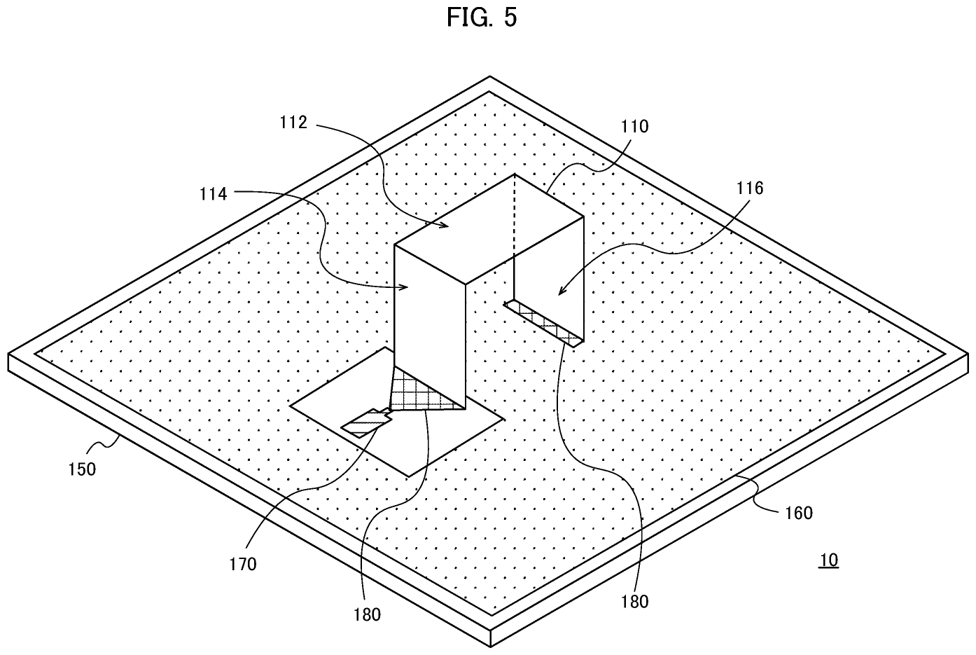

Note that, although FIG. 5 exemplifies the case where the leg part 116 included in the transmission line antenna 110 is in contact with the metal foil pattern 180 formed on the substrate 150, the leg part 126, the leg part 136, and the leg parts 146 included in the inverted L antenna 120, the inverted F antenna 130, and the branched power feeding transmission line antenna 140, respectively, may be also in contact with the metal foil pattern 180 likewise.

### 1.2. Modified Examples of Metal Plate Antenna

The metal plate antenna according to the present embodiment has been basically described above. Next, the modified examples of the metal plate antenna according to the present embodiment will be described.

Note that, although description on the following modified examples will adopt the transmission line antenna 110 as a main example, the inverted L antenna 120, the inverted F antenna 130, and the branched power feeding transmission line antenna 140 can be also modified likewise.

First, a modified example of the leg part included in the metal plate antenna will be described.

FIG. 1 exemplifies the case where the leg part 116 of the transmission line antenna 110 is bent toward the direction of the power feeding point contact part 114 on the surface in contact with the substrate 150. In a case where the leg part 116 has such a bending structure, an area in contact with the substrate 150 increases, so that the transmission line antenna 110 can more stably stand by itself on the substrate 150.

In this regard, the shape of the leg part 116 according to the present embodiment is not limited to this example.

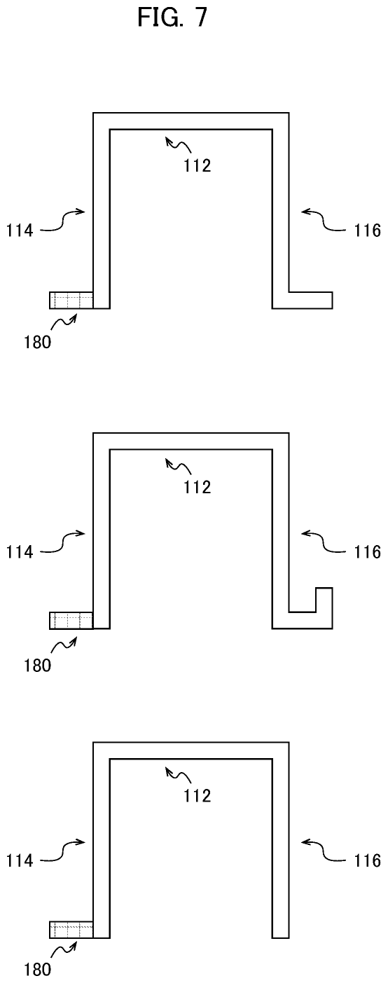

FIG. 7 is a schematic diagram for describing a modified example of the leg part 116 according to the present embodiment.

As illustrated at the upper part in FIG. 7, the leg part 116 according to the present embodiment may be bent toward a direction opposite to the power feeding point contact part 114.

Furthermore, as illustrated at the middle part in FIG. 7, the leg part 116 according to the present embodiment may be bent toward the direction opposite to the power feeding point contact part 114, and then further bent in a substantially vertical direction.

In this case, it is easy to form a fillet at a time of fixing using a conductive adhesive such as a solder, and, moreover, it is easy to check the formed fillet.

On the other hand, the leg part 116 according to the present embodiment may not have the bending structure as illustrated at the lower part in FIG. 7.

Even in this case, the transmission line antenna 110 can stand by itself on the substrate 150 by being fixed using a conductive adhesive such as a solder.

Furthermore, the transmission line antenna 110 may include opening parts 210 in the vicinity just above the contact portion of the leg part 116 and the substrate 150.

The transmission line antenna 110 is formed using a metal material, and therefore has high thermal conductivity. Hence, when fixing is performed using a conductive adhesive such as a solder, heat tends to escape upward.

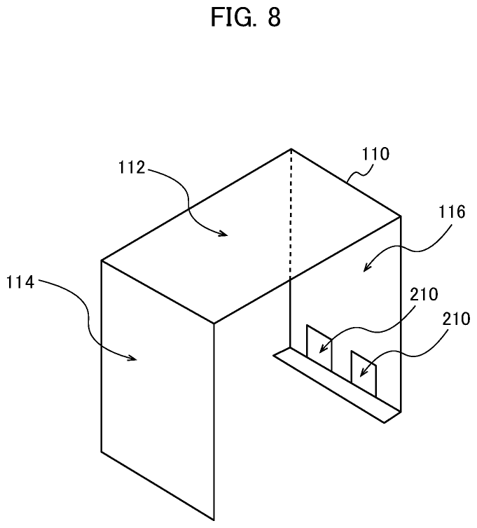

However, in a case where the opening parts 210 are formed in the vicinity just above the contact portion of the leg part 116 and the substrate 150 as illustrated in FIG. 8, it is possible to effectively prevent heat from escaping upward, and efficiently perform fixing using a conductive adhesive such as a solder.

Next, a modified example where an antenna length is secured will be described.

To secure the antenna length of interest, the metal plate antenna according to the present embodiment may have a structure such as slits 220 for causing a current to detour.

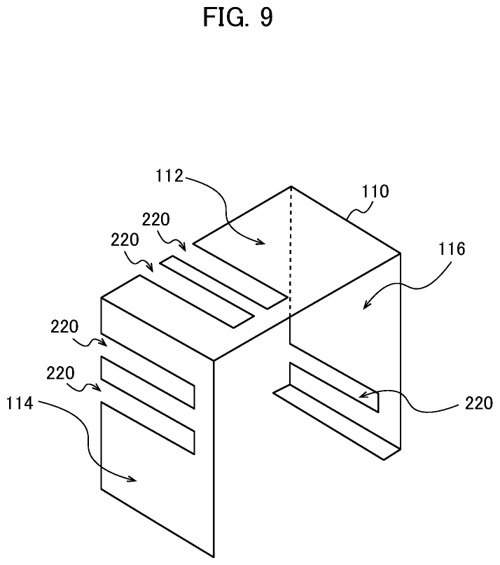

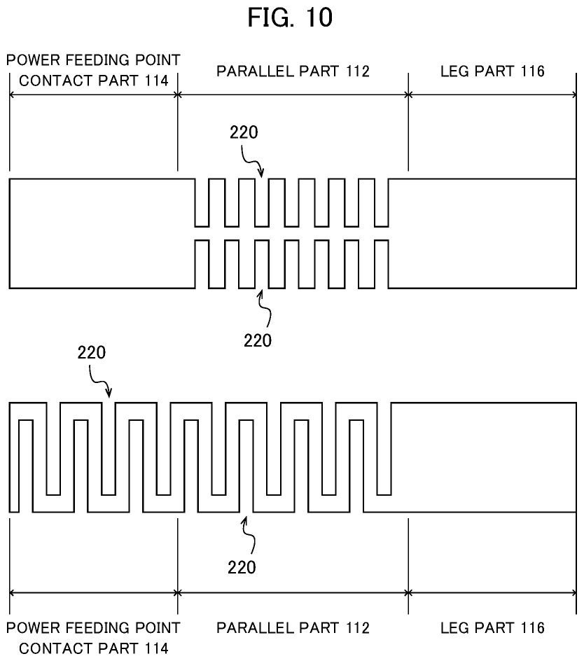

FIGS. 9 and 10 are diagrams for describing the slits 220 according to the present embodiment.

As illustrated in FIG. 9, the transmission line antenna 110 according to the present embodiment may include one or a plurality of the slits 220 in the parallel part 112, the power feeding point contact part 114, or the leg part 116.

In a case where the transmission line antenna 110 includes the slits 220 as illustrated in FIG. 9, the current flows detouring through the slits 220, so that it is possible to secure a longer antenna length defined by the lengths of the parallel part 112, the power feeding point contact part 114, and the leg part 116.

Note that, although FIG. 9 exemplifies the case where the plurality of slits 220 are formed in the same direction, a formation pattern of the slits 220 according to the present embodiment is not limited to this example.

The slits 220 according to the present embodiment may be formed in opposing two directions as illustrated at, for example, the upper part and the lower part in FIG. 10.

Furthermore, structures that are formed in the metal plate antenna and cause a current to detour are not limited to the slits 220. The structures may be the opening parts 210.

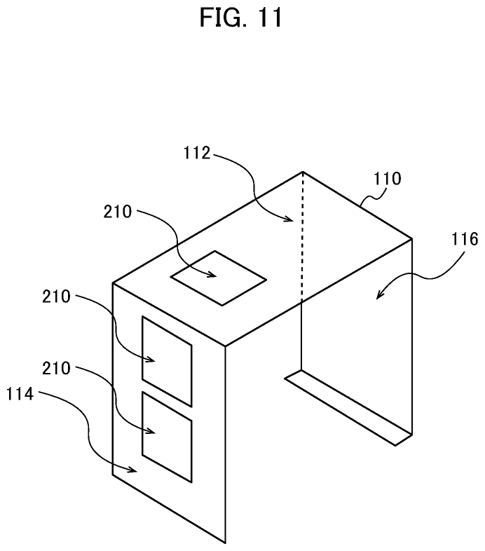

FIG. 11 is a diagram for describing the opening parts 210 as structures for causing a current to detour.

As illustrated in FIG. 11, the transmission line antenna 110 according to the present embodiment may include one or a plurality of the opening parts 210 in the parallel part 112, the power feeding point contact part 114, or the leg part 116.

In a case where the transmission line antenna 110 includes the opening parts 210 as illustrated in FIG. 11, the current flows detouring through the opening parts 210, so that it is possible to secure a longer antenna length defined by the lengths of the parallel part 112, the power feeding point contact part 114, and the leg part 116.

The slits 220 and the opening parts 210 that are the structures for causing a current to detour have been described above. Formation patterns of the slits 220 and the opening parts 210 may be designed as appropriate according to an antenna length of interest, the size of the metal plate antenna, and the like.

Next, a modified example in a case where the metal plate antenna according to the present embodiment includes stabs 240 will be described.

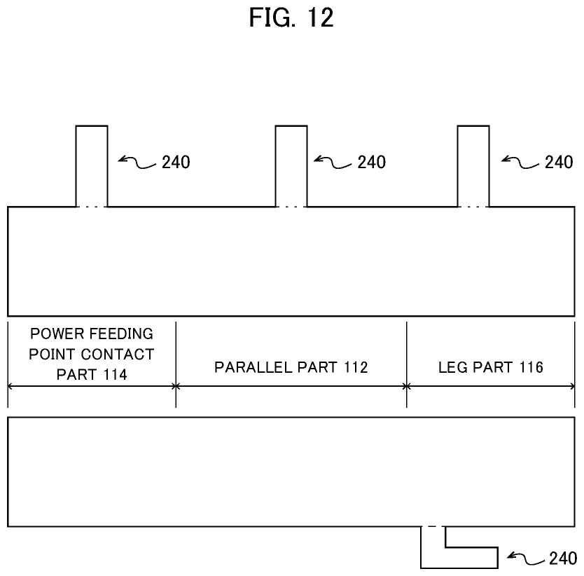

FIG. 12 is a diagram illustrating a formation example of the stabs 240 according to the present embodiment.

As illustrated in FIG. 12, the transmission line antenna 110 according to the present embodiment may include one or a plurality of the stabs 240 in one or more of the parallel part 112, the power feeding point contact part 114, and the leg part 116.

As illustrated at the upper part in FIG. 12, the stabs 240 may be formed by being extended in a direction substantially perpendicularly to a direction that connects the power feeding point contact part 114 and the leg part 116.

The stabs 240 formed as described above can cause a current to further flow in the direction perpendicular to the direction that connects the power feeding point contact part 114 and the leg part 116, and consequently can cause the transmission line antenna 110 to function as a circularly polarized antenna.

Alternatively, as illustrated at the lower part in FIG. 12, the stab 240 may be formed by being extended in the direction substantially perpendicularly to the direction that connects the power feeding point contact part 114 and the leg part 116, and then being further extended toward the substrate 150.

Furthermore, the stab 240 may be bent at, for example, a portion indicated by a two-dot-dash line in FIG. 12.

The stabs 240 according to the present embodiment can efficiently adjust a polarized wave and the antenna length.

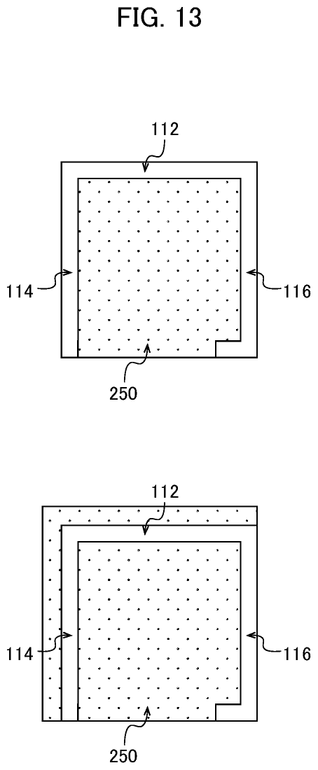

Next, a mold structure according to the present embodiment will be described. FIG. 13 is a diagram illustrating an example of the mold structure according to the present embodiment.

As illustrated at the upper part in FIG. 13, an insulation material 250 may be filled in a space surrounded by at least two of the parallel part 112, the power feeding point contact part 114, and the leg part 116 according to the present embodiment.

Alternatively, as illustrated at the lower part in FIG. 13, in the transmission line antenna 110 according to the present embodiment, in addition to the above space, the outer side of at least one of the parallel part 112, the power feeding point contact part 114, and the leg part 116 may be covered with the insulation material 250.

This mold structure that uses the insulation material 250 can effectively prevent change of the shape of the metal plate antenna.

Next, a modified example of the metal plate according to the present embodiment will be described.

The case where the metal plate antenna according to the present embodiment is formed by one metal plate has been mainly described above.

On the other hand, the metal plate antenna according to the present embodiment may be formed by a plurality of metal plates.

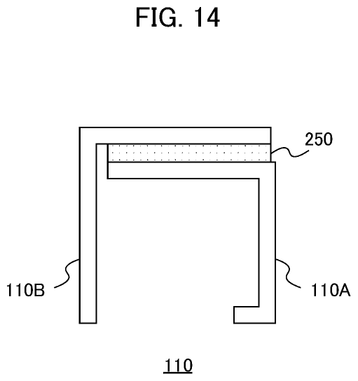

FIG. 14 is a diagram for describing the transmission line antenna 110 formed by a plurality of metal plates according to the present embodiment.

As illustrated in FIG. 14, the transmission line antenna 110 according to the present embodiment may be formed by a metal plate 110A and a metal plate 110B. While a region between the metal plate 110A and the metal plate 110B is not directly conducted, the region operates as a capacitor, so that it is possible to perform conduction at a high frequency, and it is also possible to implement an antenna function of the transmission line antenna 110.

Note that, for example, the insulation material 250 may be filled in the region between the metal plate 110A and the metal plate 110B as illustrated in FIG. 14.

In this case, it is possible to more stably keep the shape (structure) of the transmission line antenna 110.

### 2. Supplement

Heretofore, preferred embodiments of the present invention have been described in detail with reference to the appended drawings, but the present invention is not limited thereto. It is obvious that a person skilled in the art can arrive at various alterations and modifications within the scope of the technical ideas defined in the claims, and it should be naturally understood that such alterations and modifications are also encompassed by the technical scope of the present invention.

What is claimed is:

1. A metal plate antenna arranged on a substrate, the metal plate antenna comprising:
a parallel part arranged in substantially parallel to the substrate;
a power feeding point contact part extended from the parallel part substantially perpendicularly to the parallel part, and provided in contact with a power feeding point with a metal foil pattern formed on the substrate and interposed therebetween; and
a leg part formed separately from the power feeding point contact part, and extended from the parallel part substantially perpendicularly to the parallel part,
wherein a contact area of the metal foil pattern and the power feeding point is narrower than a contact area of the metal foil pattern and the power feeding point contact part.

2. The metal plate antenna according to claim 1, wherein the leg part is in contact with the metal foil pattern formed on the substrate.

3. The metal plate antenna according to claim 1, wherein the metal plate antenna is formed such that an antenna length defined by lengths of the parallel part, the power feeding point contact part, and the leg part is approximately ½ of a wavelength of a wireless signal that conforms to specific communication standards.

4. The metal plate antenna according to claim 1, wherein the metal plate antenna is formed such that an antenna length defined by lengths of the parallel part, the power feeding point contact part, and the leg part is approximately ¼ of a wavelength of a wireless signal that conforms to specific communication standards.

5. The metal plate antenna according to claim 1, wherein the metal plate antenna is a transmission line antenna.

6. The metal plate antenna according to claim 1, wherein the metal plate antenna is an inverted L antenna.

7. The metal plate antenna according to claim 1, wherein the metal plate antenna is an inverted F antenna.

8. The metal plate antenna according to claim 1, wherein the metal plate antenna is a branched power feeding transmission line antenna.

9. The metal plate antenna according to claim 1, wherein the metal plate antenna is formed by one metal plate.

10. The metal plate antenna according to claim 1, wherein at least one of the parallel part, the power feeding point contact part, and the leg part includes a slit or an opening part.

11. The metal plate antenna according to claim 1, wherein at least one of the parallel part, the power feeding point contact part, and the leg part includes a stab.

12. The metal plate antenna according to claim 1, wherein an insulation material is filled in a space surrounded by at least two of the parallel part, the power feeding point contact part, and the leg part.

13. The metal plate antenna according to claim 1, wherein the metal plate antenna is formed by a plurality of metal plates that are not in contact with each other.

14. The metal plate antenna according to claim 3, wherein the specific communication standards include ultra-wide band wireless communication.

15. An antenna device comprising:
a substrate; and
a metal plate antenna arranged on a substrate, wherein
the metal plate antenna includes:
a parallel part arranged in substantially parallel to the substrate;
a power feeding point contact part extended from the parallel part substantially perpendicularly to the parallel part, and provided in contact with a power feeding point with a metal foil pattern formed on the substrate and interposed therebetween; and
a leg part formed separately from the power feeding point contact part, and extended from the parallel part substantially perpendicularly to the parallel part, and
a contact area of the metal foil pattern and the power feeding point is narrower than a contact area of the metal foil pattern and the power feeding point contact part.
